(19) United States
(12) Patent Application Publication
(10) Pub. No.: US 2012/0324389 A1
(43) Pub. Date: Dec. 20, 2012

(54) Storage Medium Storing Computer Readable Program, Computer Program Product, Navigation Apparatus and Control Method Thereof

(75) Inventor: Jing-Shi Meng, Shanghai (CN)

(73) Assignees: MITAC RESEARCH (SHANGHAI) LTD., Shanghai (CN); MITAC INTERNATIONAL CORP., Kuei San Township (TW)

(21) Appl. No.: 13/181,496

(22) Filed: Jul. 12, 2011

(30) Foreign Application Priority Data
Jun. 16, 2011 (CN) 201110162954.9

(51) Int. Cl. G06F 3/048

(52) U.S. Cl. 715/771

(57) ABSTRACT

A storage medium storing computer readable program, a computer program product, a navigation apparatus and a control method thereof are disclosed. The navigation apparatus comprises a display unit, an input unit and a control unit. The display unit displays an electronic map and a point of interest (POI) cluster, the POI cluster includes a plurality of points of interest, and the input unit correspondingly generates a first operation signal according to a user's manipulation on the POI cluster. The control unit controls the display unit displaying the plurality of points of interest around the POI cluster according to the first operation signal.

### BACKGROUND OF THE INVENTION

1. Field of the Invention

This application claims priority of China Patent Application No. 201110162954.9, filed on Jun. 16, 2011, the contents of which are hereby incorporated by reference in their entirety for all purposes.

The present invention relates to a storage medium storing computer readable program, a computer program product, a navigation apparatus and a control method thereof, and more particularly to a navigation apparatus and its control method with the concept of a point of interest (POI) cluster including a plurality of points of interest and displaying the plurality of points of interest by a user's manipulation on the POI cluster.

2. Description of the Related Art

At present, a conventional navigation system provides an automobile navigation service by a received instant position signal transmitted from a global positioning system and a navigation software program loaded with map information. In one of the most commonly used methods, the current position of a car is used as a starting position, and a user inputs a target position, such that the automobile navigation system can plan the shortest route between the starting position and the target position and provide the shortest route for the user's reference.

A convenient feature of using the navigation system is to list points of interest (POI) at specific locations. In countryside, the points of interest may be scattered very far from each other, so that each point of interest can be listed clearly. However, in a city or any other area with points of interest at positions very close to one another, it is very difficult to display a large number of points of interest such as companies in the World Trade Center Building, exhibition sites of Taipei Flora Exposition, or food stands in Jiefun old street that are so close to one another on a display screen of a personal navigation apparatus. As to the problems of the prior art, different priorities are assigned to different types of points of interest. For example, hospitals and schools have a higher priority than restaurants or chair stores. If there are too many points of interest, the navigation system can display the points of interest with a higher priority first, such that when a user operates the navigation system, the user is unable to browse a desired point of interest due to the priority of displaying the points of interest pre-set by the navigation system. Obviously, such application is inconvenient.

In summation of the description above, the inventor of the present invention conducted extensive researches and experiments, and finally designed and developed a storage medium storing computer readable program, a computer program product, a navigation apparatus and a control method thereof, in hope of overcoming the shortcomings of the prior art and improving the practicality for industrial applications.

### SUMMARY OF THE INVENTION

The primary objective of the present invention is to overcome the shortcomings of the prior art by providing a storage medium storing computer readable program, a computer program product, a navigation apparatus and a control method thereof, so as to solve the problem of having the difficulty of displaying the points of interest browsed or selected by a navigation system when there are too many points of interest or a landmark has a plurality of points of interest.

To achieve the foregoing objective, the present invention provides a navigation apparatus, and the navigation apparatus comprises a display unit, an input unit and a control unit. The display unit is provided for displaying an electronic map and a point of interest (POI) cluster, wherein the POI cluster includes a plurality of points of interest. The input unit generates a first operation signal according to a user's manipulation on the POI cluster. The control unit is electrically coupled to the display unit and the input unit, and controls the display unit to display the plurality of points of interest around the POI cluster according to the first operation signal.

Wherein, the control unit further controls the display unit to display at least one rotate icon, such that when the input unit generates a second operation signal according to a user's manipulation on at least one rotate icon, the control unit controls the display unit to rotate a plurality of points of interest and display the points of interest at a predetermined angle according to the second operation signal.

Wherein, the control unit controls the display unit to display a plurality of points of interest in a circular rotating manner.

Wherein, the control unit further calculates and determines whether or not the number of points of interest is greater than a threshold value. If the number of points of interest is greater than the threshold value, the control unit will display a portion of the points of interest with the quantity matched with the threshold value.

Wherein, the control unit further sets a hidden point on the display unit, such that when the display unit rotates one of the points of interest to a hidden point, the control unit controls the display unit to hide the point of interest.

Wherein, the control unit further sets a display point on the display unit and controls the display unit to display one of the points of interest which has not been displayed yet from the display point.

To achieve the aforementioned objective, the present invention further provides a navigation control method for a navigation apparatus, wherein the navigation apparatus comprises a display unit, an input unit and a control unit. The navigation control method for a navigation apparatus comprises the steps of: displaying an electronic map and a point of interest (POI) cluster by the display unit, and the POI cluster including a plurality of points of interest; using the input unit to generate a first operation signal according to a user's manipulation on the POI cluster; and using the control unit to control the display unit to display a plurality of points of interest around the POI cluster according to the first operation signal.

Wherein, the navigation control method for a navigation apparatus further comprises the steps of: using the control unit to control the display unit to display at least one rotate icon; generating a second operation signal by the input unit according to the user's manipulation on at least one rotate icon; and controlling the display unit to rotate and display a plurality of points of interest at a predetermined angle by the control unit according to the second operation signal.

Wherein, the navigation control method for a navigation apparatus further comprises the step of using the control unit to control the display unit to display a plurality of points of interest in a circular rotating manner.

Wherein, the step of controlling the display unit to display a plurality of points of interest by the control unit further comprises the steps of: calculating and determining whether or not the number of points of interest is greater than a threshold value by using the control unit; and displaying a portion of points of interest with the number that is matched with the threshold value by the control unit if the number of points of interest is greater than the threshold value.

Wherein, the navigation control method for a navigation apparatus further comprises the step of: setting a hidden point on the display unit by the control unit; and if one of the points of interest on the display unit is rotated to the hidden point, then the control unit will control the display unit to hide the point of interest.

Wherein, the navigation control method for a navigation apparatus further comprises the step of setting a display point at the display unit by a control unit; and the control unit controls the display unit to display one of the points of interest that has not been displayed on the display unit yet from the display point.

To achieve the foregoing objective, the present invention further provides a computer program product, such that after the computer loads and executes the program, the aforementioned navigation control method for a navigation apparatus can be achieved.

To achieve the foregoing objective, the present invention further provides a storage medium storing computer readable program, such that after the computer loads and executes the program, the aforementioned navigation control method for a navigation apparatus can be achieved.

In summation to the description above, the storage medium storing computer readable program, the computer program product, and the navigation apparatus and the control method thereof in accordance with the present invention has one or more of the following advantages:

(1) The navigation apparatus and the navigation control method for a navigation apparatus can display a plurality of points of interest of a single POI cluster by a circular rotating manner to improve the convenience of browsing the points of interest.

(2) The navigation apparatus and the navigation control method for a navigation apparatus can use the concept of the POI cluster to integrate the plurality of points of interest into a POI cluster in order to overcome the problem of having difficulty of displaying too many and disordered points of interest on an electronic map.

(3) The navigation apparatus and the navigation control method for a navigation apparatus can control the number of points of interest on the display unit by a predetermined threshold value, and use a hidden point and a display point to hide and display the point of interest respectively, such that all points of interest can be displayed one by one to achieve the purpose of clearly displaying the points of interest.

(4) The navigation apparatus and the navigation control method for a navigation apparatus can display a plurality of points of interest at a predetermined angle according to user's manipulation on a rotate icon to achieve the effect of a quick rotational display.

### BRIEF DESCRIPTION OF THE DRAWINGS

FIG. 1 is a block diagram of a navigation apparatus in accordance with the present invention;

FIG. 2 is a schematic diagram of a navigation apparatus in accordance with a first preferred embodiment of the present invention;

FIG. 3 is a schematic diagram of a navigation apparatus in accordance with a second preferred embodiment of the present invention;

FIG. 4 is a schematic diagram of another preferred embodiment of FIG. 3;

FIG. 5 is a schematic diagram of a linked list of FIG. 4;

FIG. 6 is a first flow chart of a navigation control method for a navigation apparatus in accordance with the present invention;

FIG. 7 is a second flow chart of a navigation control method for a navigation apparatus in accordance with the present invention;

FIG. 8 is a third flow chart of a navigation control method for a navigation apparatus in accordance with the present invention;

FIG. 9 is a flow chart of a navigation control method for a navigation apparatus that hides a point of interest from a hidden point in accordance with the present invention; and

FIG. 10 is a flow chart of a navigation control method for a navigation apparatus that displays a point of interest from a display point in accordance with the present invention.

### DETAILED DESCRIPTION OF THE PREFERRED EMBODIMENTS

To make it easier to understand the technical contents of the present invention, preferred embodiments together with related drawings are used for the detailed description of the present invention as follows.

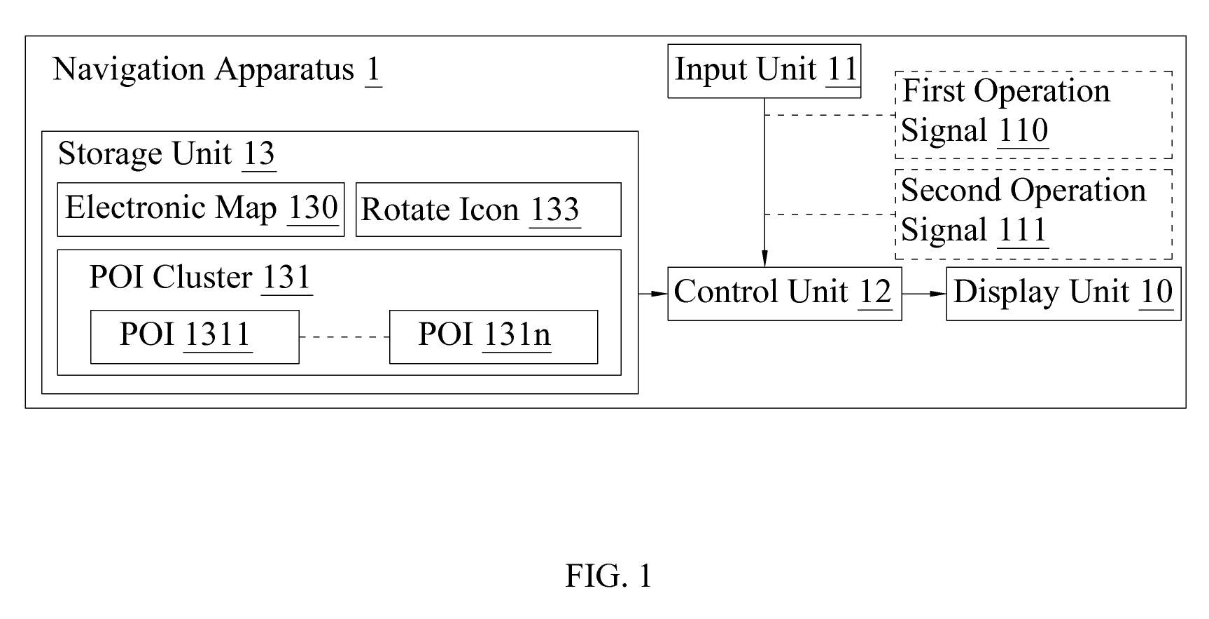

Referring to FIG. 1 for a block diagram of a navigation apparatus in accordance with the present invention, the navigation apparatus 1 comprises a display unit 10, an input unit 11, a control unit 12 and a storage unit 13, wherein the control unit 12 is electrically coupled to the display unit 10, the input unit 11 and the storage unit 13.

The storage unit 13 can be a storage media of various kinds, such as a built-in memory, an external memory (or memory card), a disk or an optical disk, and for storing a plurality of electronic maps 130 and a plurality of point of interest (POI) clusters 131, and each POI cluster 131 includes a plurality of points of interest 1311, . . . , 131n. A user can browse related points of interest 1311 . . . , 131n near a navigation point by the navigation apparatus 1 and display the electronic maps 130 and the plurality of POI clusters 131 on the display unit 10. For example, a commercial building may contain thousands of companies, and if each company represents a point of interest, then each point of interest will become too disordered and may be unable to be displayed on the display screen.

According to the concept of the present invention, a commercial building is arranged to be a POI cluster, and each company of the building may be a point of interest. Therefore, the input unit 11 can generate a first operation signal 110 according to the user's manipulation on the POI cluster and transmit the first operation signal 110 to the control unit 12. After the control unit 12 receives the first operation signal 110, the control unit 12 controls the display unit 10 to display a plurality of points of interest around the POI cluster 131 according to the first operation signal 110. Therefore, the user can select a desired point of interest 11 by using the input unit 11, and the control unit 12 can search related information of the selected point of interest through a network and provide the information of the selected point of interest to the display unit 10, such that the information of the selected point of interest can be displayed on the display unit 10.

Wherein, the display unit 10 can be a display device of various types, such as a liquid crystal display, projector, OLED display or e-Paper. The input unit 11 can be an input device of various types, such as a keyboard, mouse or touch panel. Further, the display unit 10 and the input unit 11 can be combined into a touch screen.

In addition, the control unit 12 can be a central processing unit (CPU) or a micro-processing unit, and the control unit 12 further stores at least one rotate icon 133 in the storage unit 13 and controls the display unit 10 to display at least one rotate icon 133. The input unit 11 generates a second operation signal 111 according to the user's manipulation on the rotate icon 133 and transmits the second operation signal 111 to the control unit 12. When the control unit 12 receives the second operation signal 111, the control unit 12 controls the display unit 10 to rotate and display a plurality of points of interest 1311, . . . 131n at a predetermined angle according to the second operation signal 111, so as to rotate and display a plurality of points of interest 1311, . . . 131n quickly, so as to achieve the effect of a quick browsing. Wherein, the predetermined angle can be 30°, 45°, 60°, 90°, 180°, 270° or 360°, but the present invention is not limited to these angles only, and the angle varies with the user's setting.

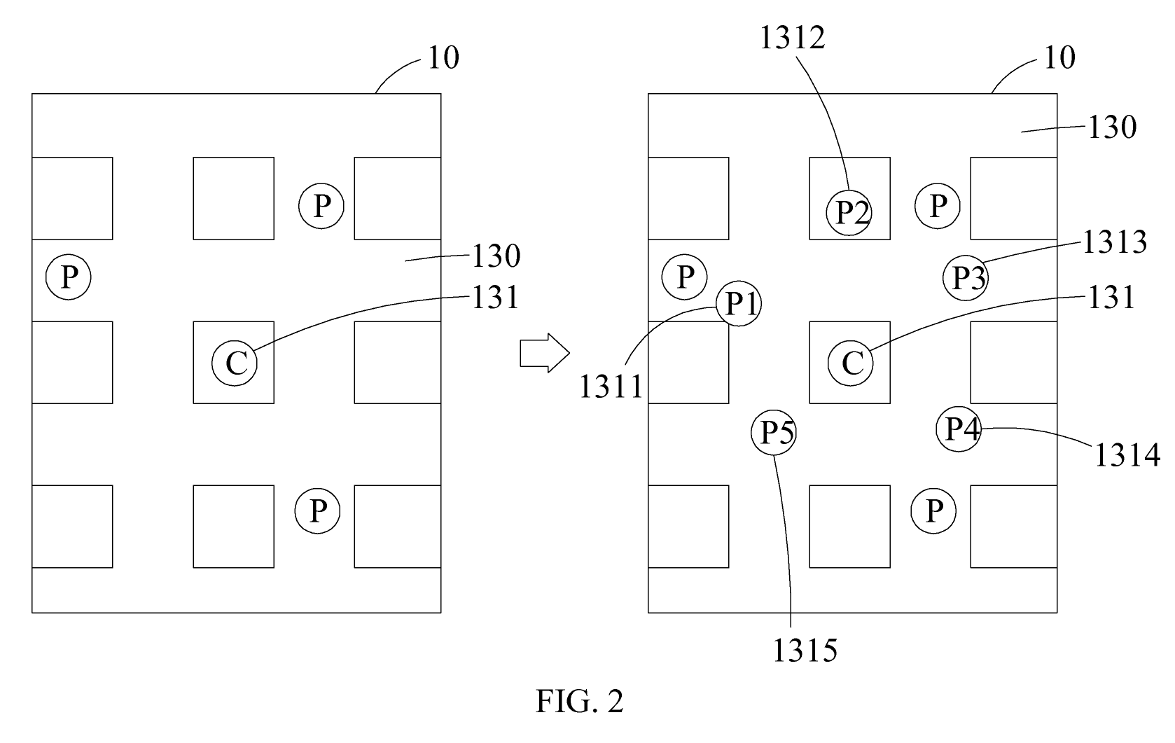

Referring to FIG. 2 for a schematic diagram of a navigation apparatus in accordance with a first preferred embodiment of the present invention, the display unit 10 of the navigation apparatus 1 displays an electronic map 130 and a point of interest (POI) cluster 131. If a user performs an operation (such as touching a touch screen by a finger) of the POI cluster 131 through the input unit 11, the input unit 11 will generate a first operation signal 110. The control unit 12 controls the display unit 10 to display a plurality of points of interest 1311, 1312, 1313, 1314 and 1315 around the POI cluster 131 in a circular rotating manner according to the first operation signal 110. In practical applications, the inventor of the present invention uses C to represent a POI cluster and P to represent a single point of interest on a display unit 10 in order to distinguish the POI cluster from the single point of interest and allow users to clearly identify the POI cluster and the single point of interest.

Although the aforementioned preferred embodiment displays the plurality of points of interest in the circular rotating manner, persons ordinarily skilled in the art can use any equivalent method that adopts a square, elliptical or linear arrangement depending on the convenience of the design.

It is noteworthy to point out that the navigation apparatus 1 can be any kind of electronic devices such as a notebook computer, a mobile phone or a personal digital assistant (PDA) capable of displaying an electronic map, a POI cluster and a plurality of points of interest.

Therefore, a user having such electronic devices can carry out an operation easily by the POI cluster displayed by the navigation apparatus of the present invention and display the plurality of points of interest of the corresponding POI cluster by a circular rotating manner. Therefore, after the user performs an operation according to the desired POI cluster, the navigation apparatus of the present invention displays the plurality of points of interest of the corresponding POI cluster, so that the user can clearly browse all points of interest to avoid the inconvenience of browsing too many points of interest on the display screen in accordance with the prior art.

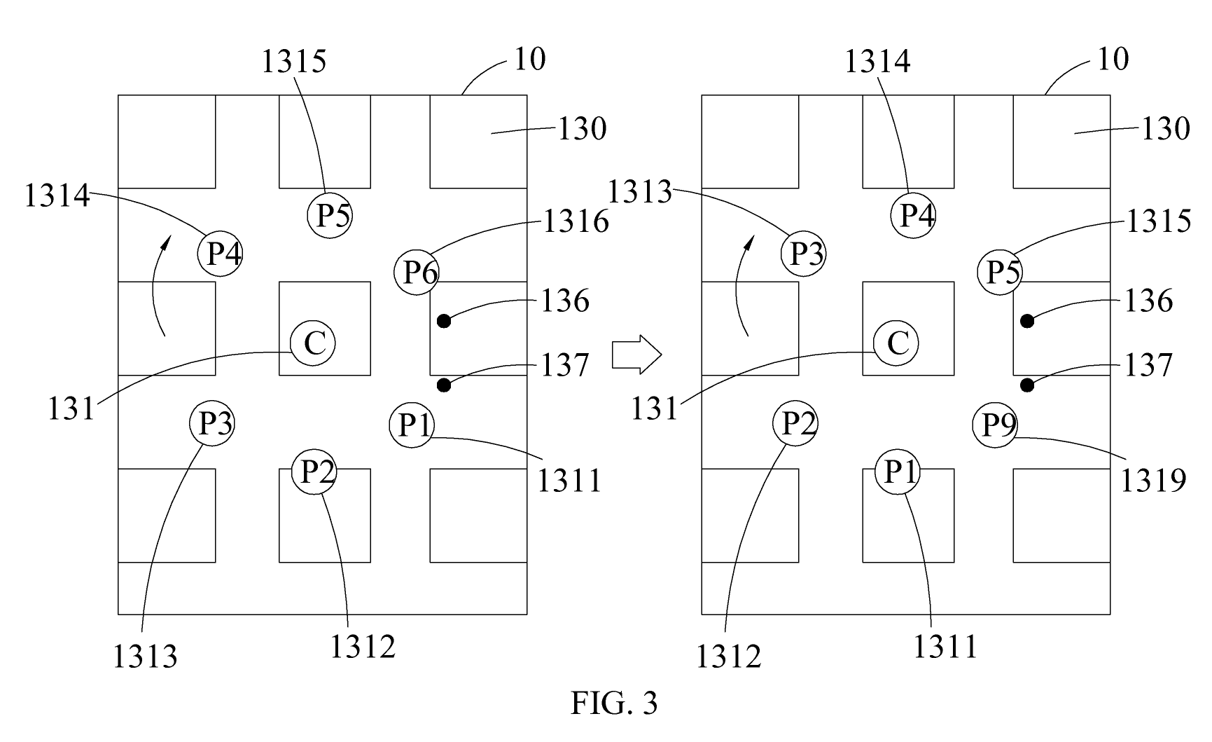

FIG. 3 shows a navigation apparatus in accordance with a second preferred embodiment of the present invention, the navigation apparatus 1 comprises a display unit 10 for displaying an electronic map 130 and a point of interest (POI) cluster 131, wherein the POI cluster 131 includes 9 points of interest 1311, . . . , 1319. In this preferred embodiment, the control unit 12 further sets a threshold value to limit the number of points of interest simultaneously displayed on the display unit 10, and such arrangement can avoid too many points of interest to be displayed disorderly on the same screen at the same time. In this preferred embodiment, the control unit 12 sets the threshold value to 6, so that after the input unit 11 generates the first operation signal 110 according to the user's manipulation on the POI cluster 131, the control unit 12 controls the display unit 10 to display the plurality of points of interest 1311, . . . , 1319 around the POI cluster 131 by a circular rotating manner according to the first operation signal 110. In addition, the control unit 12 further sets a hidden point 136 and a display point 137 on the display unit 10, wherein the hidden point 136 and the display point 137 exist in a hidden form, so that the user will not see the hidden point 136 and the display point 137 on the display unit 10. It is noteworthy that the present invention does not have any particular limitation on the positions of the hidden point 136 and the display point 137. For example, the hidden point 136 and the display point 137 may even be set at the same position depending on the user's design.

In FIG. 3, the points of interest 1311, . . . , 1316 are rotated clockwise, such that if the point of interest 1316 is rotated to the hidden point 136, the control unit 12 will control the display unit 10 to hide the point of interest 1316 and control the display unit 10 to display the point of interest 1319, so that the plurality of points of interest 1311, . . . , 1319 can be hidden/displayed alternatively to allow all points of interest 1311, . . . , 1319 to be displayed on the display unit 10 sequentially.

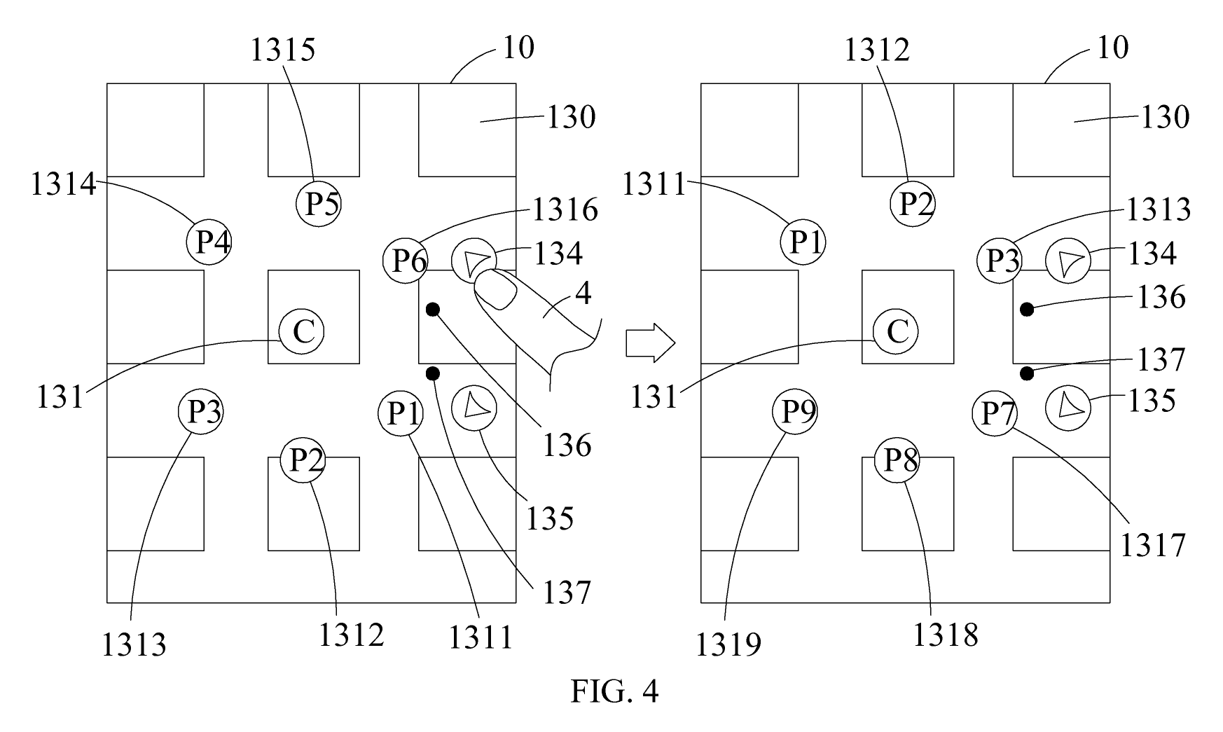

FIG. 4 shows a schematic diagram of another preferred embodiment of FIG. 3 in which the control unit 12 controls the display unit 10 to display a counterclockwise rotate icon 134 and a clockwise rotate icon 135. In this preferred embodiment, the display unit 10 and the input unit 11 are integrated into a touch screen. The input unit 11 generates a third operation signal or a fourth operation signal according to the user's manipulation on the counterclockwise rotate icon 134 or clockwise rotate icon 135. The control unit 12 controls the display unit 10 to rotate and display the points of interest at a predetermined angle according to the third operation signal or the fourth operation signal. For example, if a user uses a finger 4 to touch the counterclockwise rotate icon 134, then the control unit 12 will control the display unit 10 to rotate the point of interest counterclockwise for a round. As shown in the figure on the right, the points of interest 1311, 1312, 1313, 1317, 1318 and 1319 are displayed. Similarly, if a user touches the clockwise rotate icon 135 by a finger 4, then the control unit 12 will control the display unit 10 to turn the point of interest clockwise for a round, in order to display the point of interest that has not been displayed from the display point 137 and the point of interest proximate to the hidden point 136 that is hidden from the display unit 10, such that users can browse all points of interest quickly.

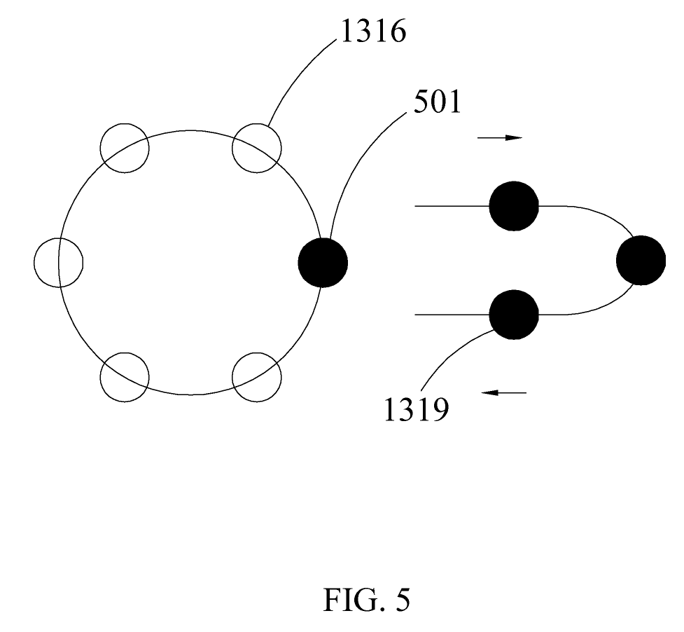

Referring to FIG. 5, which shows a schematic diagram of the linked list used in FIG. 4. The inventor of the present invention adopts two data structures for storing the points of interest in actual practices. Firstly, a linked list (such as a queue, an array, and a loop linked list, etc) stores the hidden points of interest by queuing method for displaying the points of interest on the display unit 10. In FIG. 5, the circular orbit on the left side indicates the points of interest which are stored in the linked list, and the circular orbit has a critical point 501, and the critical point 501 is formed by combining the hidden point and the display point. The right side shows the queued points of interest that have not been displayed on the display unit 10 yet, which are also the hidden points of interest. If the point of interest 1316 at the linked list on the left side is close to the critical point 501, the control unit 12 will remove the point of interest 1316 from the displayed linked list, and add the point of interest 1316 to an end of the hidden queue. A point of interest 1319 is then taken out from another end of the hidden queue, and the point of interest 1319 is added to the displayed linked list, then the procedure is repeated to display all points of interest.

It is noteworthy that the phonetic names used for representing the points of interest can be listed sequentially in a linked list and a queue, such that users can search a desired point of interest quickly based on the phonetic sequence, so as to enhance the convenience of searching for a point of interest.

Even though the process of the navigation apparatus of the present invention has been described in details and the concept of the navigation control method for a navigation apparatus in accordance with the present invention is elaborated above, flow charts are provided for illustrating the invention as follows.

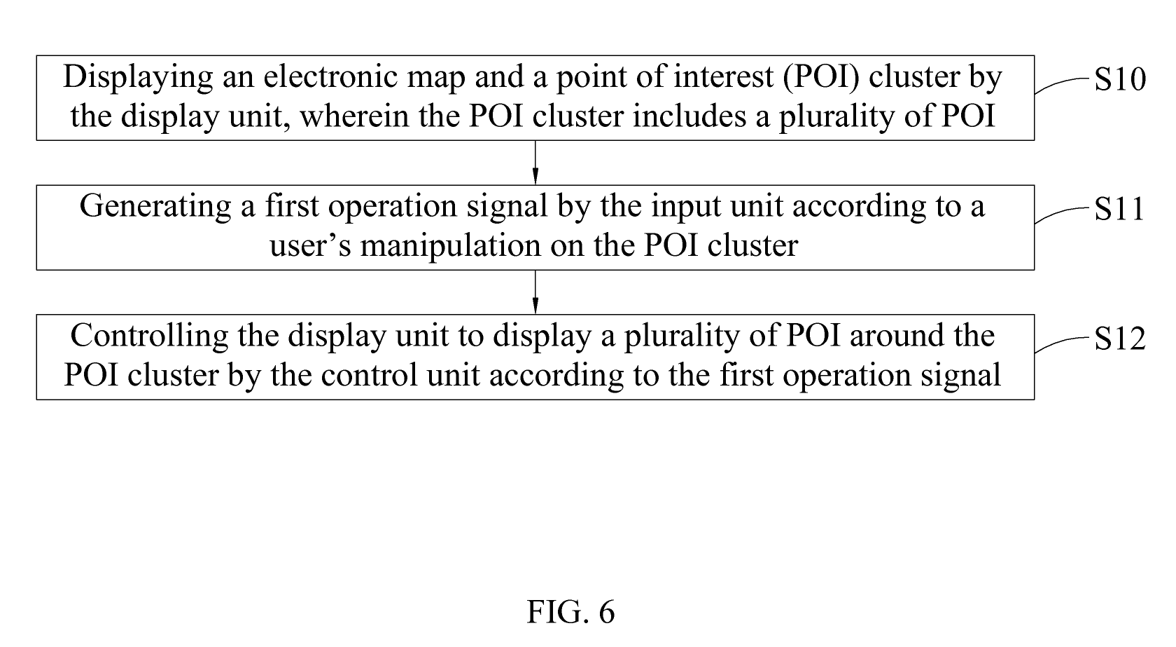

Referring to FIG. 6, which shows the first flow chart of a navigation control method for a navigation apparatus in accordance with the present invention. The navigation control method for a navigation apparatus comprising a display unit, an input unit, a control unit and a storage unit, and the control method comprises the following steps:

(S10): displaying an electronic map and a point of interest (POI) cluster by the display unit, wherein the POI cluster includes a plurality of points of interest;

(S11): generating a first operation signal by the input unit according to a user's manipulation on the POI cluster; and

(S12): controlling the display unit to display a plurality of points of interest around the POI cluster by the control unit according to the first operation signal.

In this method, the step (S12) further comprises the step of using the control unit to control the display unit to display a plurality of points of interest by a circular rotating manner.

In addition, this method further comprises the step of using a storage unit to store an electronic map and a point of interest (POI) cluster. This step preferably takes place before the step (S10), but the present invention is not limited by such sequence.

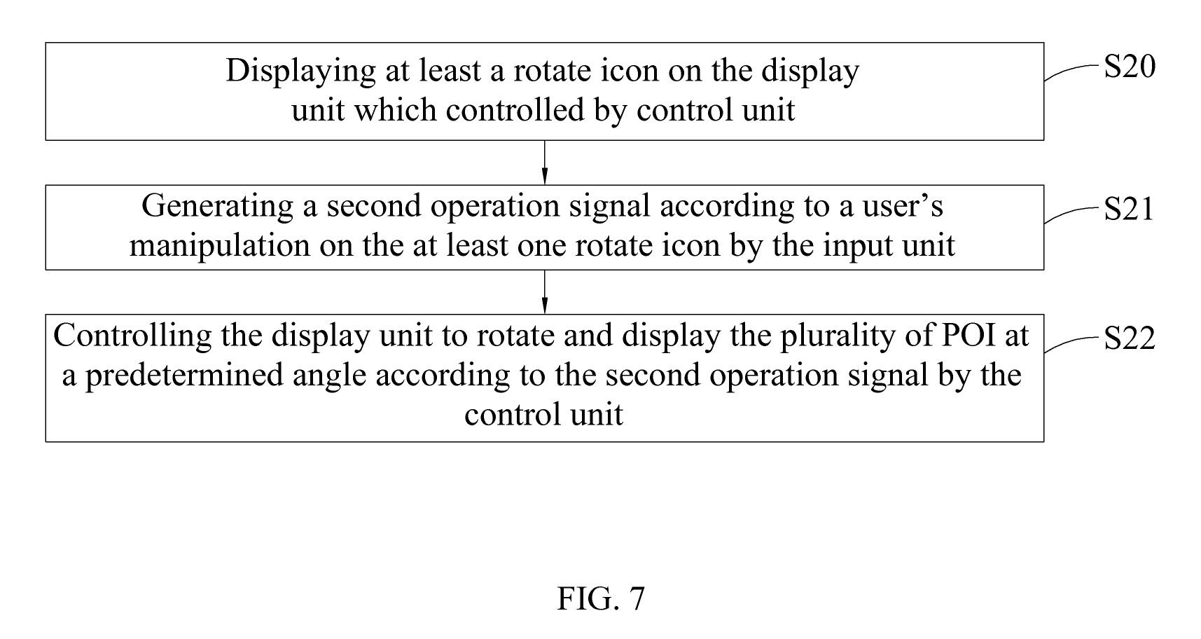

Referring to FIG. 7, which shows the second flow chart of a navigation control method for a navigation apparatus in accordance with the present invention, the control method further comprises the following steps:

(S20): controlling the display unit to display at least one rotate icon by the control unit;

(S21): generating a second operation signal according to a user's manipulation on the at least one rotate icon by the input unit; and

(S22): controlling the display unit to rotate and display the plurality of points of interest at a predetermined angle according to the second operation signal by the control unit.

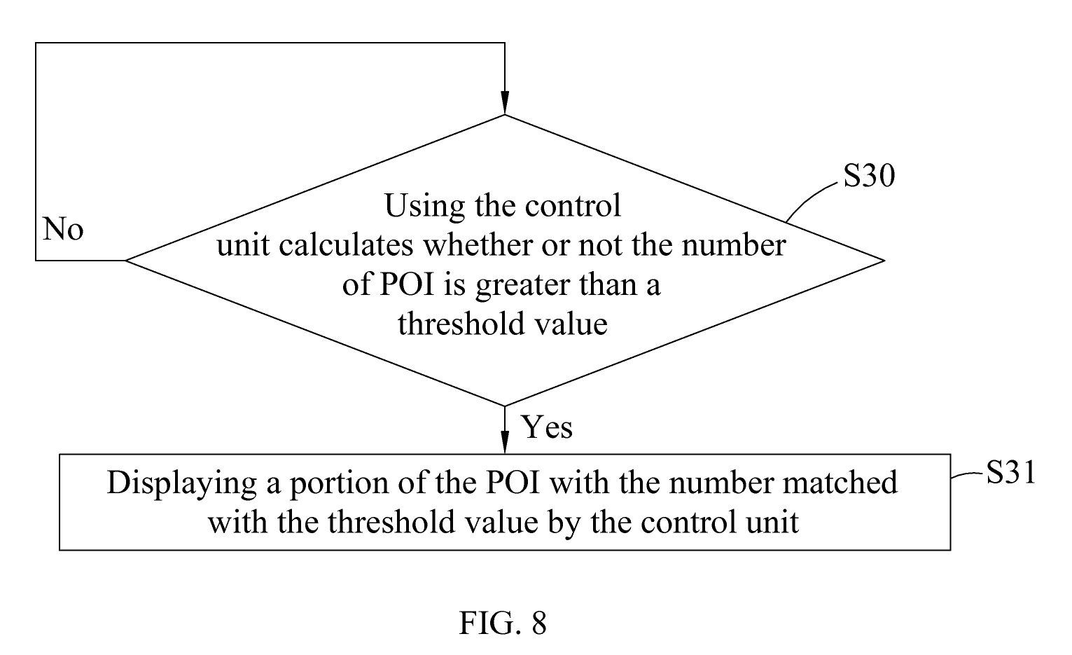

Referring to FIG. 8, which shows the third flow chart of a navigation control method for a navigation apparatus in accordance with the present invention, the step (S12) of the control method further comprises the following steps:

(S30): calculating and determining whether or not the number of points of interest is greater than a threshold value by the control unit, such that if the number of points of interest is greater than the threshold value, then go to the step (S31), or else repeat the step (S30); and

(S31): displaying a portion of the points of interest with the number matched with the threshold value by the control unit.

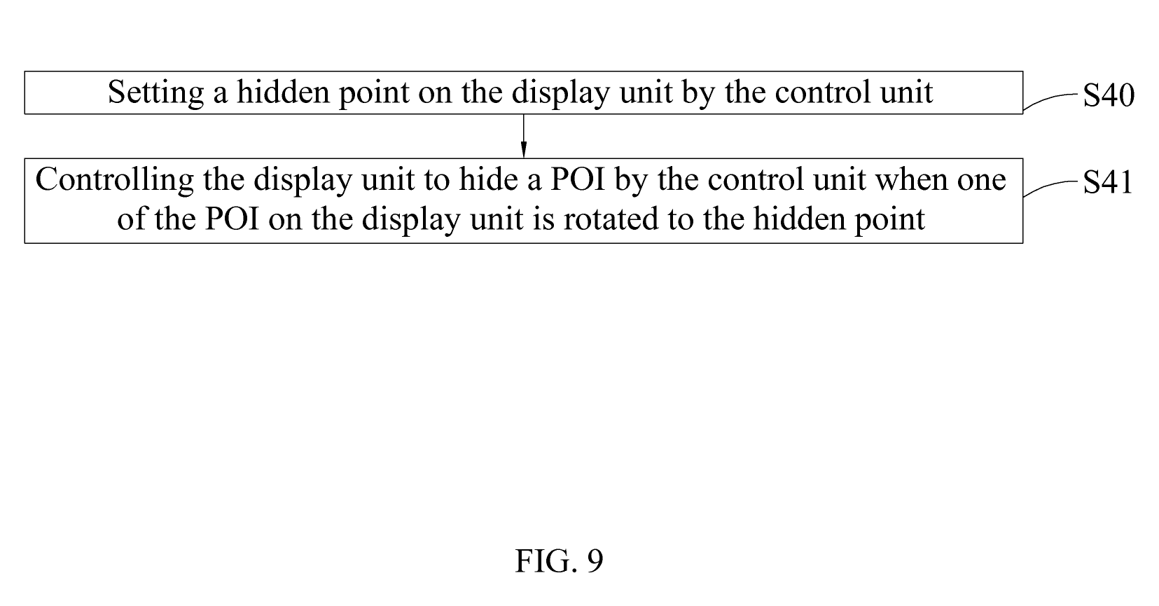

Referring to FIG. 9, which shows a flow chart of a navigation control method for a navigation apparatus that hides a point of interest from a hidden point in accordance with the present invention, the control method further comprises the following steps:

(S40): setting a hidden point on the display unit by the control unit; and

(S41): controlling the display unit to hide a point of interest by the control unit if one of the points of interest on the display unit is rotated to the hidden point.

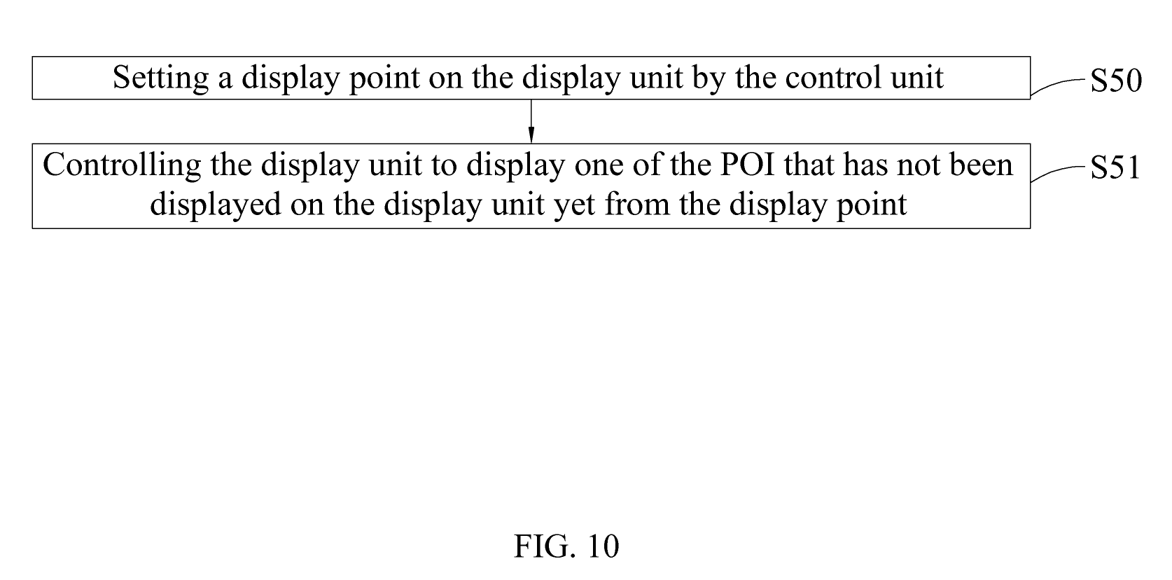

Referring to FIG. 10, it shows a flow chart of the navigation control method for a navigation apparatus that displays a point of interest from a display point in accordance with the present invention, the control method further comprises the following steps:

(S50): setting a display point on the display unit by the control unit; and

(S51): controlling the display unit to display one of the points of interest that has not been displayed on the display unit yet from the display point.

Wherein, the step (S12) may comprise the steps (S41) and (S51), and both steps (S41) and (S51) can take place simultaneously, but the present invention is not limited to such arrangement.

Each of the aforementioned steps has been described in details in the foregoing navigation apparatus, which are herein omitted for brevity.

In addition, the present invention further provides a storage medium storing computer readable program, a computer program product, navigation apparatus. The computer comprises, but not limited to, a display unit, an input unit, a control unit and a storage unit, and the storage medium can be an optical disk, a hard disk, a flash memory or any equivalent storage medium. After the computer loads and executes the program, at least the steps (S10) to (S51) of the aforementioned the navigation control method for a navigation apparatus may be performed.

In summation of the description above, the storage medium storing computer readable program, a computer program product, a navigation apparatus and the control method thereof in accordance with the present invention can determine whether or not the POI cluster is selected, and the circular rotating manner is adopted to display the corresponding points of interest of the POI cluster and set a threshold value to limit the number of displayed points of interest, so as to prevent a disordered display screen caused by too many points of interest.

The present invention further uses a hidden point and a display point to hide and display a point of interest respectively and a rotate icon for displaying all points of interest one by one quickly to achieve the convenience of browsing the points of interest.

Obviously, the present invention can improve over the prior art and comply with the patent application requirements, and thus the invention is duly filed for patent application. While the invention has been described in the specific embodiments, numerous modifications and variations could be made thereto by those generally skilled in the art without departing from the scope and spirit of the invention set forth in the claims.

What is claimed is:

1. A navigation apparatus, comprising:
a display unit displaying an electronic map and a point of interest (POI) cluster, and the POI cluster comprising a plurality of points of interest;
an input unit generating a first operation signal according to a user's manipulation on the POI cluster; and
a control unit electrically coupled to the display unit and the input unit, for controlling the display unit to display the plurality of points of interest around the POI cluster according to the first operation signal.

2. The navigation apparatus according to claim 1, wherein the control unit further controls the display unit to display at least one rotate icon when the input unit generates a second operation signal according to the user's manipulation on the at least one rotate icon, the control unit controls the display unit to rotate positions of the plurality of points of interest at a predetermined angle according to the second operation signal and thereby display the plurality of points of interest.

3. The navigation apparatus according to claim 1, wherein the control unit controls the display unit to display the plurality of points of interest in a circular rotating manner.

4. The navigation apparatus according to claim 3, wherein the control unit further calculates and determines whether or not the number of the points of interest is greater than a threshold value, and if the number of points of interest is greater than the threshold value, then the control unit displays a portion of the points of interest with the number matched with the threshold value.

5. The navigation apparatus according to claim 4, wherein the control unit further sets a hidden point on the display unit, such that if one of the points of interest on the display unit is rotated to the hidden point, the control unit controls the display unit to hide the point of interest.

6. The navigation apparatus according to claim 4, wherein the control unit further sets a display point on the display unit and controls the display unit to display one of the points of interest that has not been displayed on the display unit yet from the display point.

7. A navigation control method for a navigation apparatus, and the navigation apparatus comprising a display unit, an input unit and a control unit, and the navigation control method for a navigation apparatus comprising the following steps:
displaying an electronic map and a point of interest (POI) cluster through the display unit, and the POI cluster including a plurality of points of interest;
generating a first operation signal by the input unit according to a user's manipulation on the POI cluster; and
using the control unit for controlling the display unit to display the plurality of points of interest around the POI cluster according to the first operation signal.

8. The navigation control method for a navigation apparatus according to claim 7, further comprising the following steps:
controlling the display unit to display at least one rotate icon by the control unit;
generating a second operation signal according to the user's manipulation on the at least one rotate icon by the input unit; and
controlling the display unit to rotate and display the plurality of points of interest at a predetermined angle according to the second operation signal by the control unit.

9. The navigation control method for a navigation apparatus according to claim 7, further comprising the following step:
using the control unit to control the display unit to display the plurality of points of interest in a circular rotating manner.

10. The navigation control method for a navigation apparatus according to claim 9, wherein the step of using the control unit to control the display unit to display the plurality of points of interest further comprises the following steps:
using the control unit to compute and determine whether or not the number of points of interest is greater than a threshold value; and
using the control unit to display a portion of the points of interest with the number matched with the threshold value while the number of points of interest is greater than the threshold value.

11. The navigation control method for a navigation apparatus according to claim 10, further comprising the following steps:
setting a hidden point on the display unit by the control unit; and
if one of the points of interest on the display unit is rotated to the hidden point, controlling the display unit to hide the point of interest by the control unit.

12. The navigation control method for a navigation apparatus according to claim 10, further comprising the following steps:
setting a display point on the display unit by the control unit; and
controlling the display unit by the control unit to display one of the points of interest that has not been displayed on the display unit yet from the display point.

13. A storage medium storing computer readable program, being provided for completing the method as described in claim 7 after being loaded and executed by a computer.

14. A computer program product, being provided for completing the method as described in claim 7 after being loaded and executed by a computer.
